(19) United States
(12) Patent Application Publication
(10) Pub. No.: US 2016/0143335 A1
(43) Pub. Date: May 26, 2016

(54) FOOD PRODUCT AND METHOD FOR OBTAINING A FOOD PRODUCT OF THE FRANKFURTER SAUSAGE TYPE

(71) Applicant: Grupo Alimentario Argal, S.A., Miralcamp (ES)

(72) Inventor: Jose Maria ORTEU BARRABES, Miralcamp (ES)

(21) Appl. No.: 14/945,433

(22) Filed: Nov. 19, 2015

(30) Foreign Application Priority Data
Nov. 20, 2014 (ES) 201431503
Nov. 12, 2015 (ES) 201531636

(51) Int. Cl. A23L 1/317

(52) U.S. Cl. CPC A23L 1/3175; A23L 1/3106; A23L 1/3172; A23V 2002/00

(57) ABSTRACT

Method for obtaining a food product of the Frankfurter sausage type which comprises an elongated principal body (1) made of edible meat product provided with a plurality of small pearls, in the interior of which there is a non-meat product, wherein during the mixing of a meat mass with the small pearls, prior to a cooking stage of the meat mass, said small pearls are introduced into the meat mass in a solid state, each one of the small pearls having an exterior wall of polymeric food material such that upon applying heat to the food product, the product in the interior of the small pearl adopts a liquid state.

### RELATED APPLICATION

This application claims the benefit of priority of Spanish Patent Applications Nos. 201431503 filed Nov. 20, 2014 and 201531636 filed Nov. 12, 2015, the contents of which are incorporated herein by reference in their entirety.

### OBJECT OF THE INVENTION

The object of the present invention is to register a food product which incorporates notable innovations and advantages.

More specifically, the invention, in particular, proposes the development of a piece of cold meat or cold cut, for example sausage and similar, in particular of the Frankfurter sausage type which comprises a principal elongated body made of edible meat product as well as a method for obtaining a food product of the Frankfurter sausage type provided with a non-meat product encapsulated in pearls present in the interior of the principal body of the piece of cold meat.

### FIELD AND BACKGROUND OF THE INVENTION

A wide variety of meat products are known on the market, the cooked sausages known as Frankfurter sausages being a consumer product with great commercial success. It is common for the user or consumer to mix the sausage with sauces, such as mustard and/or tomato sauce to give it added flavor, however there is the risk that the user stains themselves when applying the sauces on the sausage or when eating it. In addition, there are Frankfurter sausages available on the market which include a solid portion of cheese in the interior, however, this configuration does not provide a homogenous distribution of flavor as a result, given that according to how the cut is made, there is the possibility of the user not capturing the flavor of the cheese together with the sausage.

Furthermore, the applicant does not know of an invention at present which provides all the characteristics which are described in this specification.

### SUMMARY OF THE INVENTION

The present invention has been developed with the aim of providing a cold meat or cold cut which is configured as a novelty within the field of application and resolves the previously mentioned drawbacks, also providing other additional advantages which will be evident from the description which is included below.

It is therefore an object of the present invention to provide a food product made from cold cut, cold meat or similar and in particular of the Frankfurter sausage type which comprises a cylindrical elongated principal body made of edible meat product and is characterized by the fact that the principal body also includes at least one additional ingredient with a pasty texture, said ingredient being provided in a plurality of small pearls with a spherical configuration arranged in a homogenous manner along the entire principal body.

Cold cut in this specification is understood as any product made with a meat or cold meat base which is processed prior to the marketing and/or consumption thereof.

Owing to these characteristics, a piece of meat or cold meat is proposed which allows the combination of flavors in one single piece in a homogenous manner such that it allows a mixed flavor to be obtained in each cut or portion cut from the piece of cold meat.

In one particularly preferred embodiment, the interior of the principal body comprises two or more different ingredients provided in a plurality of small pearls with a substantially spherical configuration.

Preferably, the additional ingredient is of a non-meat type, being a type of sauce, such as mustard, tomato sauce or similar

In a same sausage body, the product encapsulated in the interior of the small pearls can be only of one same type or the combination of two or more different products distributed in an equal or random number of small pearls.

In a particularly preferred embodiment of the invention, the small pearl has an exterior wall made from a compound different to the ingredient such that the ingredient is encapsulated within the exterior wall.

Preferably, the exterior wall of the small pearl is made of a polymeric food material.

It is also an object of the present invention to provide a method for obtaining a food product of the Frankfurter sausage type which comprises an elongated principal body made of edible meat product provided with a plurality of small pearls, in the interior of which there is a non-meat product, such as the one that has been previously described, which is characterized by the fact that during the mixing of a meat mass with the small pearls, prior to a cooking stage of the meat mass, said small pearls are introduced into the meat mass in a solid state, each one of the small pearls having an exterior wall of polymeric food material such that upon applying heat to the food product, the product in the interior of the small pearl adopts a liquid or substantially liquid state.

Owing to these characteristics, when the user consumes the product after having cooked or heated it, the product present in the interior of the small pearls is in a liquid state. The fact that prior to the consumption thereof (that is to say, prior to the heating thereof) the product encapsulated in the small pearl is in a solid state or condition before being mixed with the meat mass, prevents it from breaking, losing the desired properties thereof such as texture and flavor.

Advantageously, the exterior wall of the small pearl can include an additive with a calcium salt base which facilitates the gelification of the exterior wall and consequently the spherical form of the small pearls.

Other characteristics and advantages of the cold meat object of the present invention will be evident from the description of a preferred, but non-exclusive embodiment which is illustrated in an exemplary and non-limiting manner in the drawings which are attached, in which:

### BRIEF DESCRIPTION OF THE SEVERAL VIEWS OF THE DRAWINGS

FIG. 1—is a view of a configuration of a cold meat sausage;

FIG. 2—is a schematic view of a cold meat type of sausage divided in two portions according to the present invention; and

FIG. 3—is a schematic section of a small pearl.

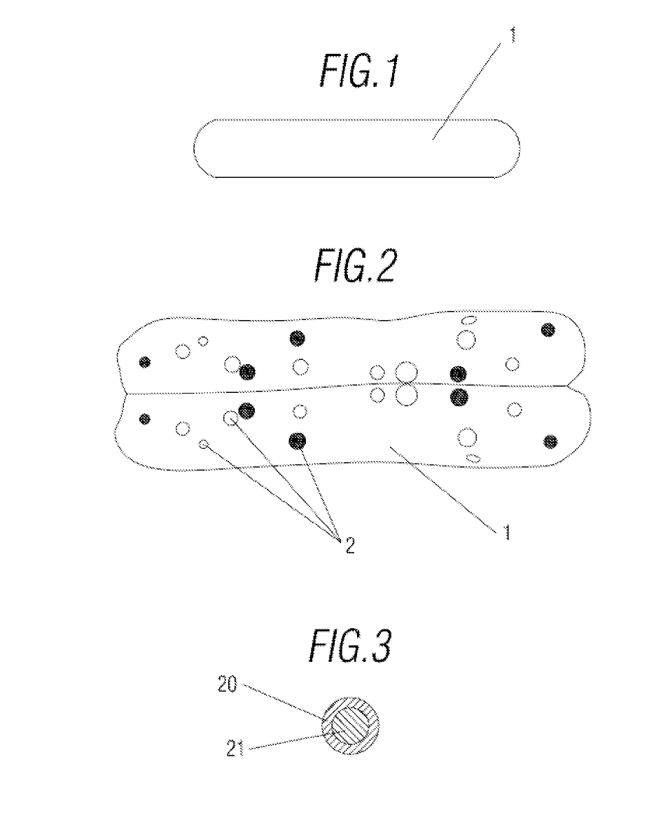

### DESCRIPTION OF SPECIFIC EMBODIMENTS OF THE INVENTION

In view of the mentioned figures and in accordance with the numeration adopted, a preferred exemplary embodiment of the invention can be observed in said figures, which comprises the parts and elements which are indicated and described in detail below.

As is shown, the piece of cold meat of a Frankfurter sausage type essentially comprises a cylindrical elongated principal body, indicated with the reference (1), which is made of an edible meat product which is obtained by means of conventional manufacturing techniques, a reason for which greater detail will not be provided on the description thereof. This principal body also includes, in the interior thereof, various ingredients with a pasty texture, such as for example mustard and tomato sauce, said foodstuffs not being limiting to the object of the invention.

Said ingredients are provided in a plurality of small pearls (2) of small size with a spherical configuration, which are arranged along the entire principal body, the small pearls with tomato sauce being graphically depicted in black shading and the small mustard pearls without shading.

The small pearl (2) has an exterior wall (20) made from a compound different to the ingredient such that the ingredient (21) is encapsulated within the exterior wall which is made from a polymeric food material, for example from gelatins, pectins, carrageenans or agar.

Furthermore, the exterior wall (20) of the small pearl (2) includes an additive with a calcium salt base such as calcium chloride or calcium lactate which, upon entering into contact with the exterior wall, cause rapid gelification.

In order to obtain the previously described product from a meat mass previously obtained by processes well-known in the art, a reason for which details will not be provided in the present description, it should be mentioned that during the mixing of the meat mass with the small pearls of additional product with reduced size, prior to a cooking stage of the meat mass, said small pearls are introduced into the meat mass in a solid and frozen state, each one of the small pearls having an exterior wall of polymeric food material. In this way, when heat is applied to the food product, for example, during the cooking thereof by means of a paella, barbecue or any other means of cooking, the product encapsulated in the small pearl adopts a liquid state which provides the user with a different sensation or texture of this substance with respect to the rest of the sausage when it is chewed by the user.

The details, forms, dimensions and other characteristics used in the manufacture of the object of the invention can be conveniently substituted for others which do not depart from the scope defined by the claims which are included below.

What is claimed is:

1. A food product made from cold cut, cold meat or similar and in particular of the Frankfurter sausage type which comprises a principal elongated body made of edible meat product, characterized by the fact that the principal body also includes at least one additional ingredient with a pasty texture, said ingredient being provided in a plurality of small pearls with a spherical configuration arranged along the entire principal body (1).

2. The food product according to claim 1, characterized by the fact that the interior of the principal body comprises two or more different ingredients provided in a plurality of small pearls with a spherical configuration.

3. The food product according to claim 1, characterized by the fact that the additional ingredient is of a non-meat type.

4. The food product according to claim 1, characterized by the fact that the additional ingredient is a sauce, such as mustard, tomato sauce or similar.

5. The food product according to claim 1, characterized by the fact that the small pearl has an exterior wall made from a compound different to the ingredient such that the ingredient is encapsulated within the exterior wall.

6. The food product according to claim 5, characterized by the fact that the exterior wall is made of a polymeric food material.

7. A method for obtaining a food product of the Frankfurter sausage type which comprises an elongated principal body made of edible meat product provided with a plurality of small pearls, in the interior of which there is a non-meat product, characterized by the fact that during the mixing of a meat mass with the small pearls, prior to a cooking stage of the meat mass, said small pearls are introduced into the meat mass in a solid state, each one of the small pearls having an exterior wall of polymeric food material such that upon applying heat to the food product, the product in the interior of the small pearl adopts a liquid state.

8. The method according to claim 7, characterized by that fact that the polymeric food material is based on a compound made from any one of gelatin, pectins, carrageenans or agar or a mixture thereof.

9. The method according to claim 7, characterized by that fact that the exterior wall of the small pearl includes an additive with a calcium salt base.
